(19) United States
(12) Patent Application Publication
(10) Pub. No.: US 2018/0275747 A1
(43) Pub. Date: Sep. 27, 2018

(54) PORTABLE EMOJI DISPLAY AND CONTROL

(71) Applicant: Camille Suzanne Campbell, Tijeras, NM (US)

(72) Inventor: Camille Suzanne Campbell, Tijeras, NM (US)

(21) Appl. No.: 15/657,673

(22) Filed: Jul. 24, 2017

Related U.S. Application Data
(60) Provisional application No. 62/476,776, filed on Mar. 25, 2017.

(51) Int. Cl. G06F 3/01; H04B 1/3827; G06K 9/00; G09G 3/20; G09G 3/36

(52) U.S. Cl. CPC G06F 3/011; H04B 1/385; G06K 9/00302; H04N 13/0203; G09G 3/2096; G09G 3/36; G09G 2354/00; G06K 9/00355

(57) ABSTRACT

A method and apparatus for expanding the avenues of a person's emotional expression beyond cyberspace, a device comprised of one or more display modules and a control module designed to change and express the emotional state of the user is presented. This is accomplished by the display of emoji representations through form, color, and blink frequency. In the transportation application, it could limit or possibly stop road rage or misunderstandings. In the static application (e.g. entryways) it can prepare the visitor for the mood of the resident, the information gained from the invention can affect the outcome of the visit.

### CROSS-REFERENCE TO RELATED APPLICATIONS

This application claims the benefit of Applicants' prior U.S. provisional application No. 62/476,776, filed on Mar. 25, 2017, which is incorporated herein by reference.

### STATEMENT REGARDING FEDERALLY SPONSORED RESEARCH OR DEVELOPMENT

None

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of Invention

This invention is an innovation in the area of social interaction utilizing a graphical display controlled by various electronic means.

### Background

In modern society, people are interested in sharing their mood and emotional status with others. On the Internet, we express ourselves on social media so our contacts, followers, and potentially all of cyberspace can know how our day is progressing and how we feel, often in real time. An unmet need, which this invention is intended to satisfy, is the ability to convey the emotional state of the user to the extra-cyber world by means of a graphical display, which illuminates an emoji or emoticon consistent with that state. These emojis can be of different colors indicative of emotion, and can be blinking. This invention has a safety feature in the automotive embodiment, in that an apologetic emoji displayed could circumvent a road-rage incident. The emoji display is mounted to be easily seen by the target audience. The state of the display (or multiple displays) is controlled by a control module by remote means to be described in more detail below.

### SUMMARY OF THE INVENTION

The subject invention consists of a control module and one or several display modules. The display module presents an icon emoji formed by multiple light sources in familiar patterns, colors, and blink frequency to express the mood of the operator. The information containing the emotional state is entered either by tactile or voice commands and is encoded and transmitted either wired or wirelessly using a variety of methods to the display module where it is decoded and displayed on the output panel. The emotional state can be modified as frequently as the user desires, including emoji expression, color and blink frequency consistent with operator safety considerations. The emoji display can either be a separate panel in the entryway, structural, or transportation application, or integrated into existing head and tail lights in the transportation application.

### BRIEF DESCRIPTION OF THE SEVERAL VIEWS OF THE DRAWING(S)

FIG. 1 shows an example of an emoji display system with a display module communicating with the control module.

FIG. 2 shows some typical emojis.

FIG. 3 shows the subsystems and function of a display module.

FIG. 4 shows the subsystems and function of a control module.

FIGS. 5A, 5B, and 5C show possible mounting locations for the display module.

FIG. 6 illustrates an overview of an emoji display and a smartphone enabled control function.

FIG. 7 illustrates an overview of an emoji display and a biometric data device enabled control function.

FIG. 8 illustrates an overview of an emoji display and a biometric data device enabled control function.

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

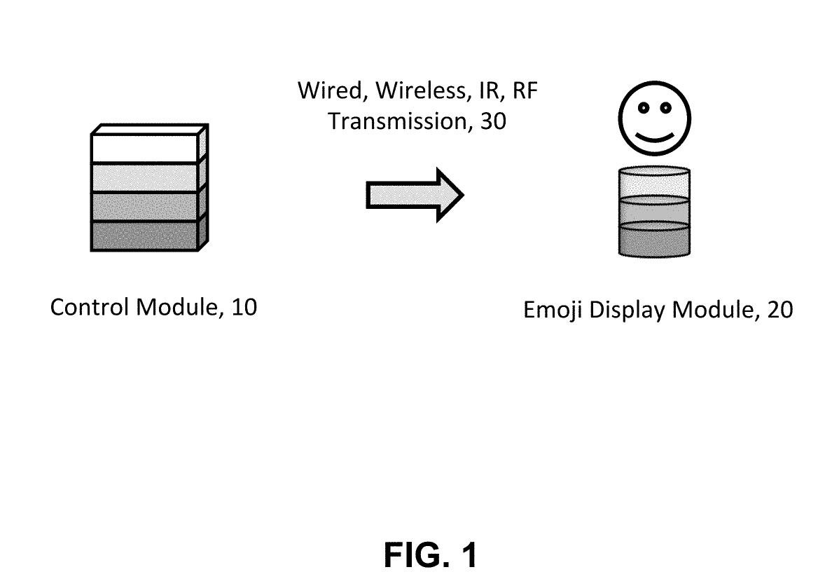

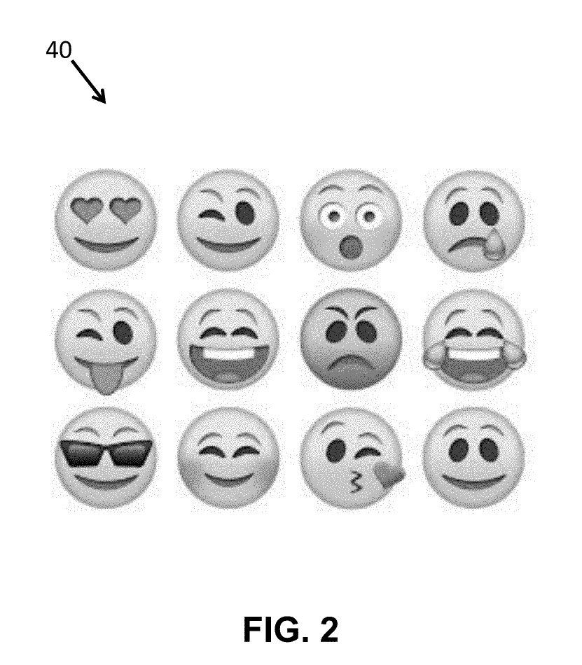

FIG. 1 shows an example of a device comprised of a control module 10 and at least one, and potentially multiple, emoji display modules 20. FIG. 2 shows examples of typical emoji symbols (which includes emoticons).

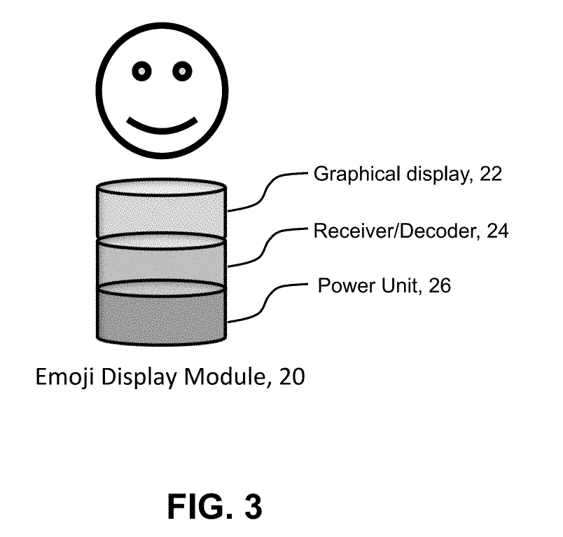

FIG. 3 shows a typical emoji display module 20, which is comprised of three sub-modules: 1) a graphical display 22 (e.g., LED, OLED, LCD display); 2) a power source 26 and/or connectors to an external power source (not shown); and 3) a receiver/decoder 24 to intercept control signals from the control module 10 and translate them to commands to energize and illuminate a particular emoji pattern on the emoji display module 20.

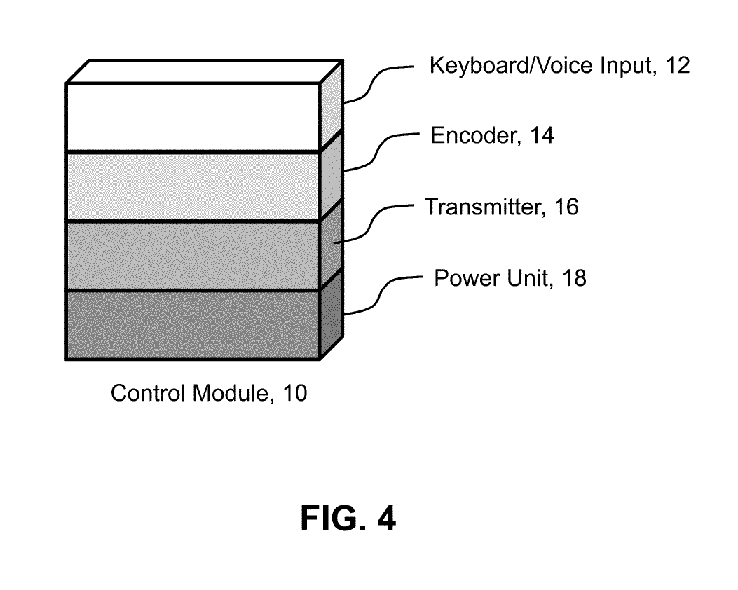

FIG. 4 shows a typical control module 10, which is comprised of four sub-modules: 1) an input module 12 which activates by tactile (keyboard) or by voice means or by biometric sensor means a selected emoji pattern, color, and blink frequency corresponding to a current emotional state; 2) a power source 18 and/or connectors to an external power source (not shown); 3) an encoding module 14 which takes the selection data and converts it to a form suitable for transmission; and 4) a transmission module 16 which passes the signals to the emoji display module 20 by a wired, wireless, Wi-Fi, Bluetooth, IR, near-field RF, or other electromagnetic connection.

The construction materials and processes of the sub-modules are described in accordance with standard practice. The encoding/decoding algorithms required to control the emoji patterns are of established standard digital logic and requires no elaboration here. The emoji pattern is constructed by an array of light sources, either using clusters of monochromatic light sources, or a fewer number of multicolored light sources.

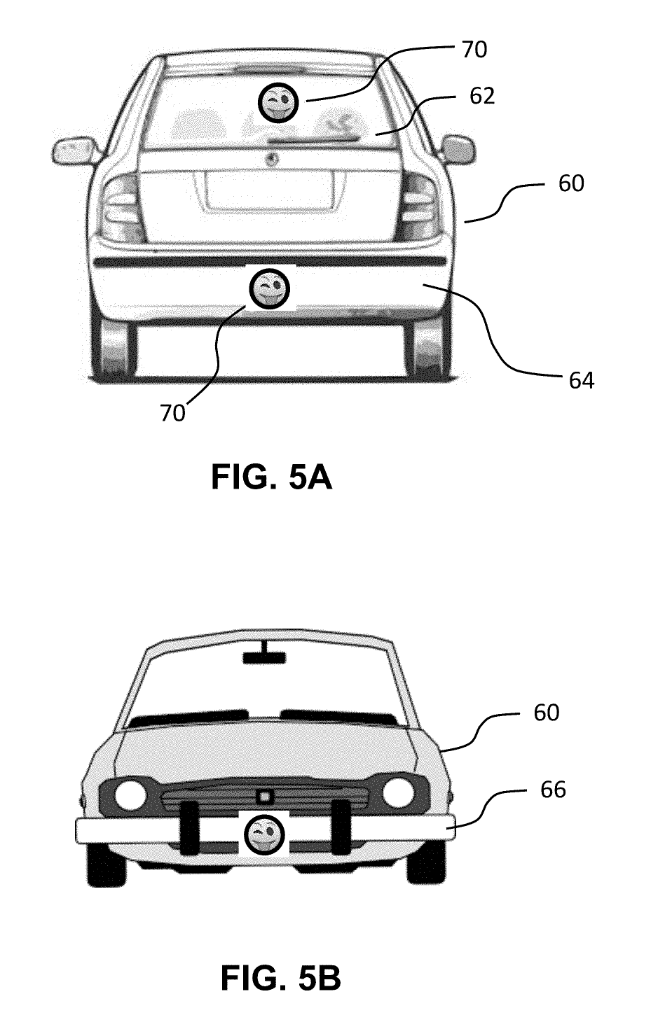

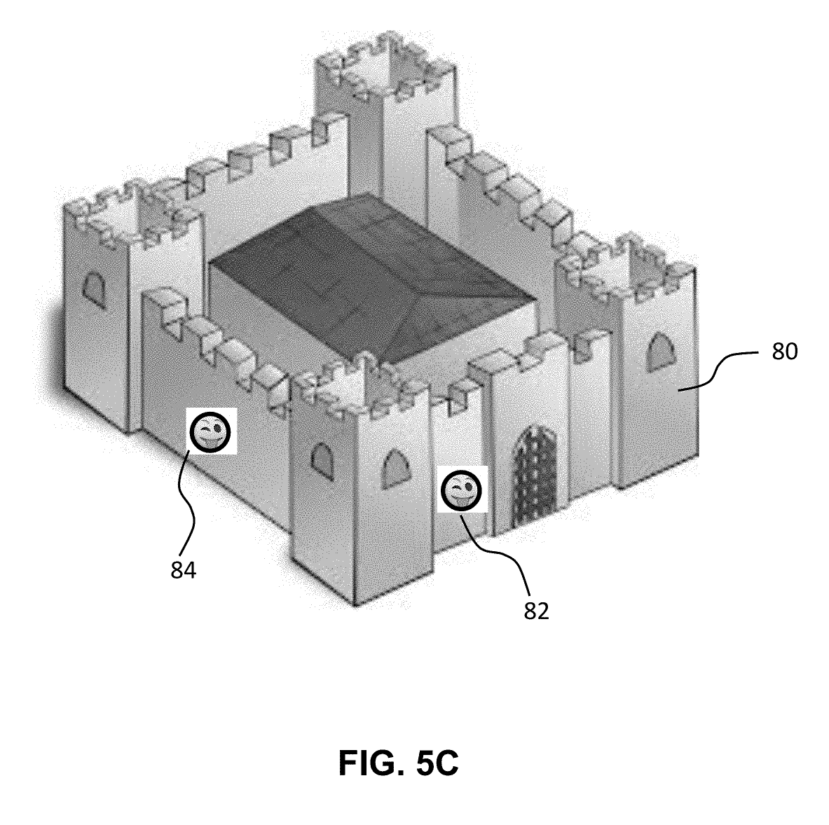

FIGS. 5A, 5B, and 5C show possible locations for a portable emoji display 70 on automobiles 60 (e.g., back windshield 62, rear bumper 64, or front bumper 66); other forms of transportation (e.g., bicycles, motorcycles), clothing or hand carried accessories (e.g. purse or backpack), entryways 82, and structures 84 (such as buildings or homes).

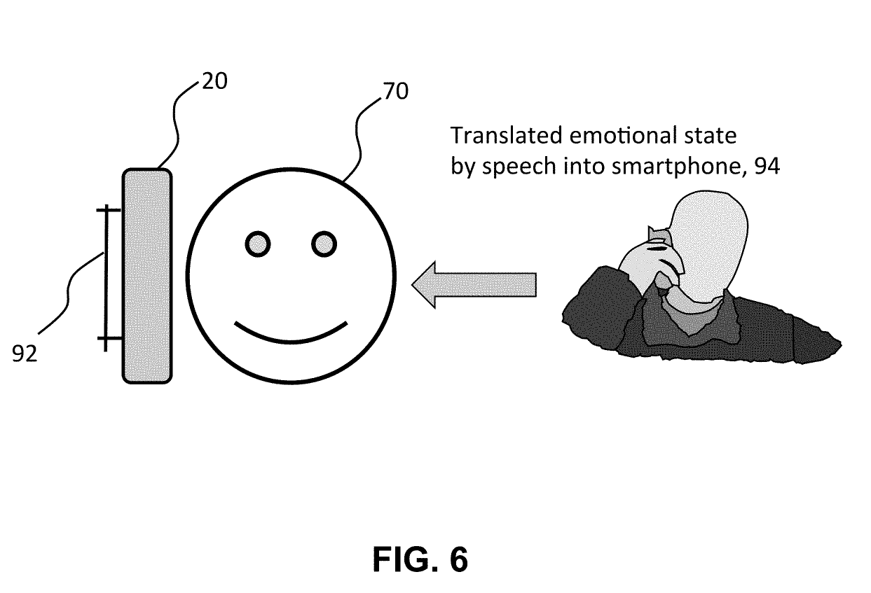

FIG. 6 shows a first embodiment where the emoji display 70 is integrated with a means of relocating (attaching) it (for example: spring clip, adhesive backing, Velcro® hook and loop fastening, or pin), on various surfaces not limited to walls, clothing, accessories (e.g. purse or backpack), or even exterior surfaces of a vehicle (bicycle, scooter, or automobile). In one embodiment, a signal representing the owner's emotional state is remotely transmitted (e.g., via Bluetooth communication protocols) to the receiver 24 on the display module 20 via a smartphone application activated by voice commands and/or keywords that the receiver 24 uses to change the display 22. Alternately, the smartphone transmission is activated by pushing an icon of an emoji on the smartphone screen in a dedicated app. Note that where we refer to a “smartphone”, we broadly intend this to include other computer devices, such as laptops, pads, desktop computers, and the like.

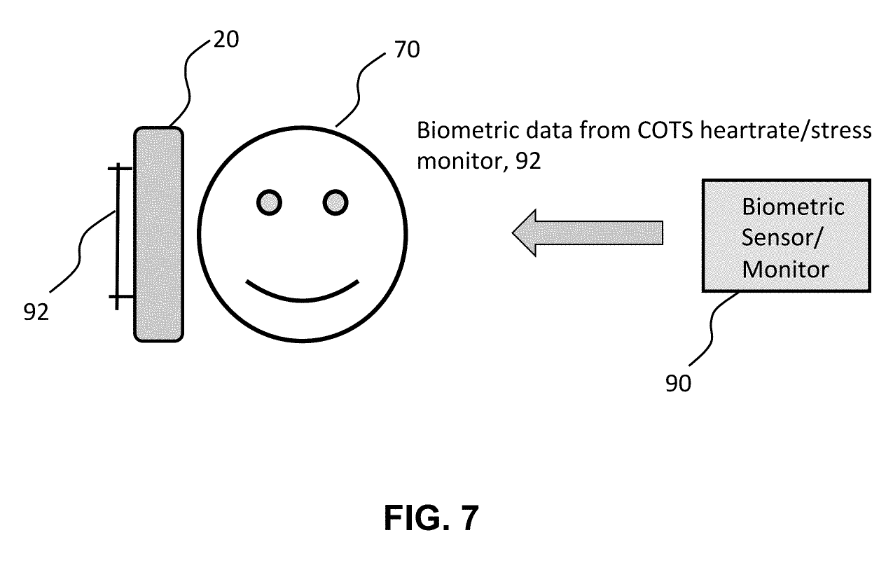

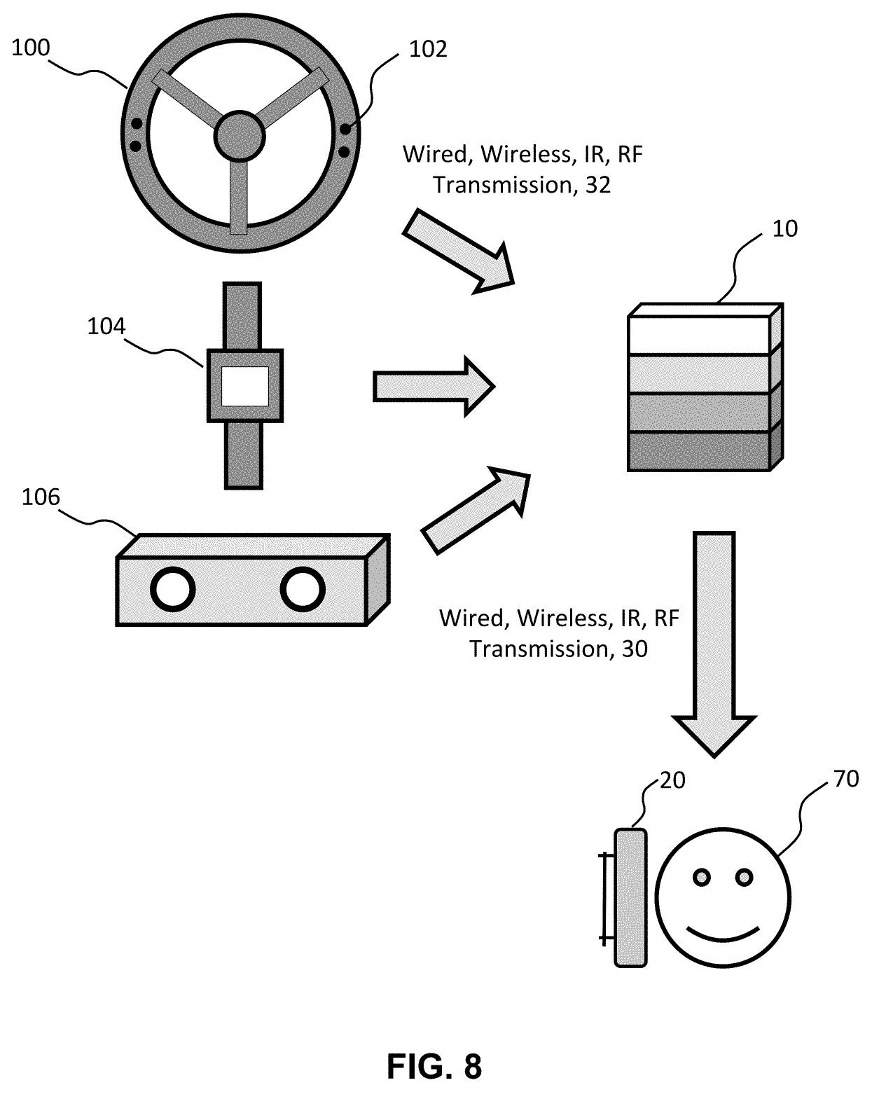

FIGS. 7 and 8 show an alternate embodiment, where a signal representing the owner's emotional state is transmitted to the receiver 24 on the display module 20 based on a biometric stream of data 92 collected by one or more sensors 90 monitoring the emotional state of the owner of the emoji display system. Some examples of devices that can generate biometric response data include: FitBits® 104 (heart rate, temperature, and blood pressure), Basis™ bands (galvanic response) 104, smart watches 104, skull caps with electrodes (EGG), and dual-video (3-D imaging) cameras (e.g., Kinnect® devices 106) in an automobile or business/work environment. The dual-video (3-D imaging) cameras can be used for monitoring facial expressions (e.g., happy face, sad face), or for monitoring/tracking hand gestures (e.g., a friendly gesture, i.e., waving; or a gesture of frustration). Biometric sensors can be located in the seat of an automobile, or embedded (102) in the steering wheel 100, among other locations. An emotional state can also be monitored (and a control signal generated by) a computer-voice-activated response controller (e.g., SIRI: “How are you feeling?” . . . . OWNER: “I'm feeling happy”), or by monitoring stress in the Owner's voice or skin resistance via the galvanic response of a FitBit type of smart wrist or smartwatch device. The biometric sensors can be COTS (Commercial Off The Shelf) devices.

The disclosed embodiments are illustrative, not restrictive. While specific configurations of the emoji display and control technology have been described, it is understood that the present invention can be applied to a wide variety of emoji control technologies. There are many alternative ways of implementing the invention.

What is claimed is:

1. An emoji display system, comprising a control module in communication with an emoji display module, for displaying emoji symbols on the display module representing the emotional state of a person.

2. The emoji display system of claim 1, wherein the control module comprises a keyboard/voice input module; an encoder module; a transmitter module; and a power unit.

3. The emoji display system of claim 1, wherein the emoji display module comprises a graphical display; a receiver/decoder module; and a power unit.

4. The emoji display system of claim 3, wherein the graphical display comprises an organic or inorganic liquid crystal display.

5. The emoji display system of claim 1, wherein the emoji display module is attachable to arbitrary surfaces by a clip, tape, hook & loop system, or pin.

6. The emoji display system of claim 1, further comprising a smartphone and smartphone application means for translating voice command keywords into a signal that's transmitted to the control module for changing the emoji image on the emoji display module.

7. The emoji display system of claim 1, further comprising means for translating a stream of biometric data generated by a biometric sensor into a signal that's transmitted to the control module for changing the emoji image on the emoji display module.

8. The emoji display system of claim 1, wherein the biometric sensor is selected from the group consisting of: a FitBit type wrist sensor, a smartwatch, a Basis bands sensor, a skull-cap with sensors, and a dual-video camera 3-D imaging system.

9. The emoji display system of claim 1, wherein transmission between the control module and the emoji display module is by wired, wireless, Wi-Fi, Bluetooth, IR, near-field RF, or other electromagnetic connection.

10. An emoji display system, comprising a control module in communication with an emoji display module, for displaying emoji symbols on the display module representing the emotional state of a person; wherein the control module comprises a keyboard/voice input module; an encoder module; a transmitter module; and a power unit; and wherein the emoji display module comprises a graphical display; a receiver/decoder module; and a power unit; and wherein the graphical display comprises an organic or inorganic liquid crystal display; and wherein the emoji display module is attachable to arbitrary surfaces by a clip, tape, hook & loop system, or pin; and wherein transmission between the control module and the emoji display module is by wired, wireless, Wi-Fi, Bluetooth, IR, near-field RF, or other electromagnetic connection.

11. A method of displaying an emoji symbol on a remote display module, comprising:
a) generating and inputting information to a control module that represents an emotional state of a person;
b) generating and encoding a control signal from the control module that represents an emoji symbol corresponding to the emotional state of the person;
c) transmitting the control signal to a remote emoji display module;
d) decoding the control signal in the emoji display module; and
e) displaying the corresponding emoji symbol on the display module.

12. The method of claim 11, wherein transmitting the control signal in step c) comprises using a wired means for transmitting the signal.

13. The method of claim 11, wherein transmitting the control signal in step c) comprises using a wireless means for transmitting the signal.

14. The method of claim 13, wherein the wireless means for transmitting the signal comprises Wi-Fi, Bluetooth, IR, near-field RF, or other electromagnetic means for transmitting.

15. The method of claim 11, wherein step a) comprises inputting information to a smartphone; and then using a smartphone application to generate, encode, and transmit the control signal to a remote emoji display module.

16. The method of claim 11, wherein step a) comprises generating biometric data from a biometric sensor, and inputting the biometric data into the control module, wherein the biometric data is correlated by the control module to an emotional state of a person.

17. The method of claim 14, wherein the biometric sensor is selected from the group consisting of: a FitBit type wrist sensor, a smartwatch, a Basis bands sensor, a skull-cap with electrodes, and a dual-video camera 3-D imaging system.

18. The method of claim 16, wherein generating biometric data comprises measuring a person's blood pressure using a FitBit type wrist sensor or a smartwatch.

19. The method of claim 16, wherein generating biometric data comprises measuring a person's pulse rate using a FitBit type wrist sensor or a smartwatch.

20. The method of claim 16, wherein generating biometric data comprises measuring a person's brain wave EEG signals using a skull cap with electrodes.

21. The method of claim 16, wherein generating biometric data comprises measuring a person's skin resistance using a Basis bands wrist sensor.

21. The method of claim 16, wherein generating biometric data comprises monitoring a person's facial expressions using a dual-video camera 3-D imaging system.

22. The method of claim 16, wherein generating biometric data comprises monitoring a person's hand gestures using a dual-video camera 3-D imaging system.
